(19) United States
(12) Patent Application Publication
(10) Pub. No.: US 2026/0355556 A1
(43) Pub. Date: Nov. 12, 2026

(54) FLUID EJECTION MECHANISM AND FIRE EXTINGUISHING DEVICE

(71) Applicant: ZHEJIANG YUAN FIRE FIGHTING EQUIPMENT CO., LTD., Quzhou (CN)

(72) Inventors: Guojian Yang, Quzhou (CN); Zhenyu Yang, Quzhou (CN)

(73) Assignee: ZHEJIANG YUAN FIRE FIGHTING EQUIPMENT CO., LTD., Quzhou (CN)

(21) Appl. No.: 19/749,106

(22) Filed: Jul. 21, 2026

Related U.S. Application Data
(63) Continuation-in-part of application No. 19/463,910, filed on Jan. 29, 2026, now Pat. No. 12,714,898.
Application No. 19/463,910 is a continuation of application No. PCT/CN2025/116875, filed on Aug. 26, 2025.

(30) Foreign Application Priority Data
Aug. 7, 2024 (CN) 202411078956.3
Dec. 31, 2024 (CN) 202411993470.2
Aug. 6, 2025 (CN) 202511095008.5
Aug. 6, 2025 (CN) 202521661147.5

(51) Int. Cl. A62C 31/03; B05B 3/00; B05B 3/02

(52) U.S. Cl. CPC A62C 31/03; B05B 3/003; B05B 3/0202

(57) ABSTRACT

A fluid ejection mechanism and a fire extinguishing device are disclosed. The fluid ejection mechanism comprises a connecting pipe, an insertion pipe, a rotating assembly drivingly connected to the insertion pipe for driving the insertion pipe to rotate about its own central axis, and a spray nozzle fixedly mounted on the insertion pipe and in communication with an interior of the insertion pipe.

### CROSS REFERENCE TO RELATED APPLICATIONS

This application is being filed as a continuation-in-part of U.S. patent application No. 19/463,910, filed on Jan. 29, 2026, which is a continuation of International Application No. PCT/CN2025/116875 filed on Aug. 26, 2025, which claims priority to Chinese Patent Application No. 202411993470.2, filed on Dec. 31, 2024, Chinese Patent Application No. 202411078956.3, filed on Aug. 7, 2024, Chinese Patent Application No., 202521661147.5, filed On Aug. 6, 2025, and Chinese Patent Application No.,202511095008.5, filed On Aug. 6, 2025, the entire contents of which are incorporated herein by reference.

### TECHNICAL FIELD

The present disclosure relates to the technical field of fire extinguishing, and in particular to a fire extinguishing device and a fluid ejection mechanism thereof.

### BACKGROUND

In existing fire-fighting extinguishing devices, in particular in turret heads or monitoring devices having multiple degrees of rotational freedom, the locking and positioning of the fluid ejection mechanism is typically achieved by a structure in which a pin cooperates with a detent slot. In such structures, a fixed pipe or fixed seat is generally provided on one side, and a rotatable rotating member is provided on the other side, the rotating member being provided with detent slots distributed circumferentially; the pin is inserted into the corresponding slot manually or electrically to achieve positioning and rotation.

However, because the pin and the detent slot are typically made of rigid metal materials, and because a small fit clearance must be used in the design in order to ensure locking stability, sliding friction occurs between the pin and the inner wall of the slot when the rotation angle is switched, and sticking or jamming may even occur due to an excessively small clearance or thermal expansion of the material; the friction and jamming phenomena significantly increase the load on the drive components (such as a motor) and the actuating components.

In the early stage of a fire, the fire source is typically small in range but develops rapidly, and the success of extinguishment often depends on whether the fire point can be precisely located and effectively covered at the first opportunity. The precision of the rotation angle directly determines whether the fire extinguishing medium (such as water, foam, or dry powder) can be accurately projected onto the target area. If the fluid ejection mechanism has an angular deviation, the fire extinguishing medium will deviate from the fire source and fail to form an effective coverage layer, thereby delaying the optimal extinguishing window and possibly allowing the fire to spread. In addition, precise angular adjustment can reduce waste of the fire extinguishing medium and avoid secondary damage (such as water damage or foam contamination) to surrounding non-fire areas.

Therefore, in the early stage of a fire, the fluid ejection mechanism must achieve highly precise angular rotation to ensure that the fire extinguishing device can complete the extinguishing action in a very short time and suppress the fire while it is still nascent; how to improve rotational precision is a technical problem that presently needs to be solved.

### SUMMARY OF THE INVENTION

An object of the present disclosure is to provide a fluid ejection mechanism, so as to solve the problem in the background art that the fluid ejection mechanism of existing fire extinguishing devices has low rotation-angle precision, which affects the fire extinguishing effect.

In order to achieve the foregoing object, the present disclosure provides a fluid ejection mechanism comprising a connecting pipe, an interior of the connecting pipe permitting fluid to flow therethrough for introducing an external fluid; an insertion pipe, an end of the insertion pipe being inserted into an end of the connecting pipe and in fluid communication therewith, wherein the insertion pipe and the connecting pipe are capable of rotating relative to each other circumferentially at the location of insertion; a rotating assembly, drivingly connected to the insertion pipe, for driving the insertion pipe to rotate about its own central axis; and a spray nozzle, fixedly mounted on the insertion pipe and in communication with an interior of the insertion pipe, wherein the spray nozzle is capable of swinging synchronously with rotation of the insertion pipe so as to directionally spray the introduced fluid to a target location; wherein a first space is provided at the end of the connecting pipe; a second space corresponding to the first space is provided at the end of the insertion pipe; and the fluid ejection mechanism further comprises a limiting member, the limiting member being inserted into an interior of the first space and the second space so as to achieve mutual axial limiting between the connecting pipe and the insertion pipe, while allowing the connecting pipe and the insertion pipe to rotate relative to each other circumferentially.

In one or more embodiments, the first space is an annular groove provided along at least a partial circumference of an outer peripheral surface of the end of the connecting pipe; the second space is an annular hole provided along a partial circumference of the end of the insertion pipe.

In one or more embodiments, the first space is an annular hole provided along a partial circumference of the end of the connecting pipe; the second space is an annular groove provided along at least a partial circumference of an outer peripheral surface of the end of the insertion pipe.

In one or more embodiments, the limiting member comprises: a first limiting portion and a second limiting portion, respectively located on two radial sides of the connecting pipe and each inserted into the first space and the second space; and a connecting portion, connecting the first limiting portion and the second limiting portion and, in a radial direction of the connecting pipe, clamping the two portions tightly against the connecting pipe.

In one or more embodiments, the first limiting portion and the second limiting portion are each detachably connected to the connecting portion; the connecting portion is provided with a slot, and the limiting portions are provided with insertion blocks adapted to fit the slot; the insertion blocks are inserted into the slot so as to fixedly connect the connecting portion to the limiting portions.

In one or more embodiments, the limiting member further comprises an elastic bushing, the elastic bushing being mounted between the insertion block and the slot so that the insertion block and the slot are in interference fit with each other.

In one or more embodiments, the limiting member further comprises a locking member, detachably fixed to an outer periphery of the insertion block so as to fix the connecting portion to the limiting portions.

In one or more embodiments, the limiting member further comprises a fixing member, detachably fixed within the insertion block so as to fix the connecting portion to the first limiting portion and the second limiting portion.

In one or more embodiments, the first space is a through hole extending radially at the end of the connecting pipe; the second space is an annular groove extending circumferentially on an outer peripheral surface of the end of the insertion pipe; the limiting member is configured as a ball and is simultaneously embedded in the first space and the second space so as to axially fix the two relative to each other.

In one or more embodiments, the first space is an annular groove extending circumferentially on an outer peripheral surface of the end of the connecting pipe; the second space is a through hole extending radially at the end of the insertion pipe; the limiting member is configured as a ball and is simultaneously embedded in the first space and the second space so as to axially fix the two relative to each other.

In one or more embodiments, a first blocking piece is fixedly mounted at an opening of the through hole of the first space near the outer peripheral surface of the connecting pipe, for preventing the limiting member from disengaging from the first space.

In one or more embodiments, in a length direction of the first space, the first blocking piece abuts against the limiting member.

In one or more embodiments, an elastic member is further provided between the first blocking piece and the limiting member and is compressed by both.

In one or more embodiments, a support portion is provided at an opening of the through hole of the first space near an inner peripheral surface of the connecting pipe, the support portion having a reduced bore diameter, so as to support the limiting member and prevent the limiting member from falling out of the first space.

In one or more embodiments, the first space is an annular groove extending circumferentially on an inner peripheral surface of the end of the connecting pipe; the second space is an annular groove extending circumferentially on an outer peripheral surface of the end of the insertion pipe; the limiting member is a ball and is simultaneously embedded in the first space and the second space so as to axially fix the two relative to each other.

In one or more embodiments, the first space is an annular groove extending circumferentially on an outer peripheral surface of the end of the connecting pipe; the second space is an annular groove extending circumferentially on an inner peripheral surface of the end of the insertion pipe; the limiting member is a ball and is simultaneously embedded in the first space and the second space so as to axially fix the two relative to each other.

In one or more embodiments, the connecting pipe is provided with a first communication hole extending radially and communicating with the first space, the limiting member entering the first space and the second space through the first communication hole, and a second blocking piece is mounted at an opening of the first communication hole to prevent the limiting member from falling out of the first communication hole.

In one or more embodiments, the rotating assembly comprises: a rotary drive source, for providing rotational power; a speed reducer, an input end of which is connected to the rotary drive source and an output end of which is connected to the insertion pipe, for transmitting the power output by the rotary drive source so as to rotate the insertion pipe about its central axis; and a position sensor, connected to the speed reducer, for monitoring a rotation angle output by the speed reducer.

In one or more embodiments, a driving member is fitted on an output shaft of the rotary drive source; the speed reducer comprises: a receiving shaft, meshed with the driving member and rotating by receiving power from the driving member; an output shaft, connected to the end of the insertion pipe, for driving the insertion pipe to rotate synchronously therewith; an intermediate shaft, located between the receiving shaft and the output shaft, the number of intermediate shafts being not less than one; a first transmission member, the number of which is plural, respectively provided on the receiving shaft and the intermediate shaft; and a second transmission member, the number of which is plural, respectively provided on the intermediate shaft and the output shaft.

In one or more embodiments, the sensor is a potentiometer, provided with a plug-in hole.

In one or more embodiments, a rotating shaft is mounted within the plug-in hole, the rotating shaft being connected to the end of the receiving shaft so as to rotate synchronously therewith.

In one or more embodiments, a rotating shaft is mounted within the plug-in hole, the rotating shaft being connected to the end of the output shaft so as to rotate synchronously therewith.

In one or more embodiments, a rotating shaft is mounted within the plug-in hole, the rotating shaft being connected to the end of the intermediate shaft so as to rotate synchronously therewith.

In one or more embodiments, a rotating shaft is mounted within the plug-in hole, the rotating shaft being connected to the end of the insertion pipe so as to rotate synchronously therewith.

In one or more embodiments, the plug-in hole is adapted to fit the end of the insertion pipe.

The present application further discloses a fire extinguishing device, comprising a stator, a rotor fitted around an exterior of the stator and rotating about the stator, a coil winding provided on the stator or the rotor; and a medium channel provided through the stator, the medium channel being used for the flow of a fire extinguishing medium; wherein the device further comprises the fluid ejection mechanism described above.

In one or more embodiments, the rotating assembly of the fluid ejection mechanism is mounted on the rotor, such that the fluid ejection mechanism rotates synchronously with the rotor; a liquid-inlet end of the connecting pipe of the fluid ejection mechanism is movably connected to the stator, and a second sealing structure is provided between the liquid-inlet end of the connecting pipe and the stator.

In one or more embodiments, the second sealing structure comprises a second sealing groove provided on the stator, and a second sealing ring mounted in the second sealing groove, the second sealing ring being in contact with an inner wall of the liquid-inlet end of the connecting pipe.

In one or more embodiments, a first bearing and a second bearing may be installed between the rotor and the stator.

In one or more embodiments, a retaining ring may be provided on an outer wall of the stator, wherein the retaining ring abuts against the second bearing in an axial direction so as to limit relative separation between the stator and the rotor in the axial direction.

Compared with the prior art, the present disclosure provides a fluid ejection mechanism and a fire extinguishing device, having the following beneficial effects:

The fluid ejection mechanism and the fire extinguishing device thereof movably connect the connecting pipe and the insertion pipe by means of the limiting member through engagement or rolling engagement, and by reducing the contact area between the limiting member and the first space and the second space, the frictional force during rotation of the insertion pipe is reduced, jamming of the insertion pipe is avoided, the rotation of the insertion pipe is made smoother, and the rotation angle of the insertion pipe is made more precise, so that the fire extinguishing medium can precisely cover the fire source to extinguish it.

In addition, through the provision of the position sensor, the rotation angle of the insertion pipe can be monitored and fed back, ensuring that the insertion pipe rotates into position and avoiding an angular deviation of the rotating pipe, so that the fire extinguishing medium can be accurately projected onto the target area, thereby forming an effective coverage layer on the fire source, preventing the fire from spreading and even extinguishing the fire source.

### BRIEF DESCRIPTION OF THE DRAWINGS

FIG. 1 is a schematic structural view of a fluid ejection mechanism according to one or more embodiments of the present application.

FIG. 2 is a schematic top view of the insertion pipe 200 and the connecting pipe 100 according to one or more embodiments of the present application.

FIG. 3 is a cross-sectional view taken along line A-A in FIG. 2.

FIG. 4 is a schematic structural view of the connecting pipe 100 according to one or more embodiments of the present application.

FIG. 5 is a schematic structural view of the insertion pipe 200 according to one or more embodiments of the present application.

FIG. 6 is a schematic structural view of another connecting pipe 100 according to one or more embodiments of the present application.

FIG. 7 is a schematic structural view of another insertion pipe 200 according to one or more embodiments of the present application.

FIG. 8 is a schematic structural view of the limiting member 600 according to one or more embodiments of the present application.

FIG. 9 is a schematic structural view of another limiting member 600 according to one or more embodiments of the present application.

FIG. 10 is a schematic top view of the connecting portion 620 in FIG. 9.

FIG. 11 is a cross-sectional view taken along line B-B in FIG. 10.

FIG. 12 is a schematic structural view of the second limiting portion 680 according to one or more embodiments of the present application.

FIG. 13 is a schematic structural view of another second limiting portion 680 according to one or more embodiments of the present application.

FIG. 14 is a partial enlarged view of portion A in FIG. 13.

FIG. 15 is a schematic structural view of the connecting portion 620 according to one or more embodiments of the present application.

FIG. 16 is a cross-sectional view taken along line C-C in FIG. 15.

FIG. 17 is a schematic structural view of yet another limiting member 600 according to one or more embodiments of the present application.

FIG. 18 is a schematic top view of the connecting portion 620 in FIG. 17.

FIG. 19 is a schematic structural view of the limiting member 600 according to one or more embodiments of the present application.

FIG. 20 is a schematic structural view of the second limiting portion 680 in FIG. 19.

FIG. 21 is a partial enlarged view of portion B in FIG. 20.

FIG. 22 is a schematic structural view of the connecting portion 620 in FIG. 19.

FIG. 23 is a schematic top view of the connecting pipe 100 and the insertion pipe 200 according to one or more embodiments of the present application.

FIG. 24 is a cross-sectional view taken along line D-D in FIG. 23.

FIG. 25 is a schematic structural view of yet another connecting pipe 100 according to one or more embodiments of the present application.

FIG. 26 is a schematic top view of the connecting pipe 100 and the insertion pipe 200 according to one or more embodiments of the present application.

FIG. 27 is a cross-sectional view taken along line E-E in FIG. 26.

FIG. 28 is a schematic structural view of another insertion pipe 200 according to one or more embodiments of the present application.

FIG. 29 is a schematic top view of the connecting pipe 100 and the insertion pipe 200 according to one or more embodiments of the present application.

FIG. 30 is a cross-sectional view taken along line F-F in FIG. 29.

FIG. 31 is a schematic top view of the connecting pipe 100 and the insertion pipe 200 according to one or more embodiments of the present application.

FIG. 32 is a cross-sectional view taken along line G-G in FIG. 31.

FIG. 33 is a partial enlarged view of portion C in FIG. 32.

FIG. 34 is a partial enlarged view of portion D in FIG. 32.

FIG. 35 is a schematic top view of the connecting pipe 100 and the insertion pipe 200 according to one or more embodiments of the present application.

FIG. 36 is a cross-sectional view taken along line H-H in FIG. 35.

FIG. 37 is a partial enlarged view of portion E in FIG. 36.

FIG. 38 is a schematic structural view of yet another connecting pipe 100 according to one or more embodiments of the present application.

FIG. 39 is a schematic top view of the connecting pipe 100 and the insertion pipe 200 according to one or more embodiments of the present application.

FIG. 40 is a cross-sectional view taken along line I-I in FIG. 39.

FIG. 41 is a schematic structural view of yet another insertion pipe 200 according to one or more embodiments of the present application.

FIG. 42 is a schematic structural view of the rotating assembly 300 and the position sensor 330 according to one or more embodiments of the present application.

FIG. 43 is a schematic structural view of the speed reducer 320 according to one or more embodiments of the present application.

FIG. 44 is a schematic structural view of the rotary drive source 310 and the driving member 311 according to one or more embodiments of the present application.

FIG. 45 is a schematic structural view of the output shaft 324 according to one or more embodiments of the present application.

FIG. 46 is a schematic structural view of the rotating assembly 300 and the position sensor 330 according to another one or more embodiments of the present application.

FIG. 47 is a schematic view of the internal structure of the position sensor 330 and the speed reducer 320 in FIG. 41 [sic].

FIG. 48 is a schematic structural view of the position sensor 330 connected to the output shaft 324 according to one or more embodiments of the present application.

FIG. 49 is a schematic structural view of the position sensor 330 connected to the insertion pipe 200 according to one or more embodiments of the present application.

FIG. 50 is a schematic structural view of the position sensor 330, the synchronous rotation ring 250, and the output shaft 324 according to one or more embodiments of the present application.

FIG. 51 is a schematic structural view of the rotating shaft 332 and the limiting block 334 according to one or more embodiments of the present application.

FIG. 52 is a schematic structural view of the position sensor 330 cooperating with the end of the insertion pipe 200 according to one or more embodiments of the present application.

FIG. 53 is a schematic structural view of the housing 321 and the output shaft 324 in FIG. 52.

FIG. 54 is a side structural view of the insertion pipe 200 and the bolt 230 in FIG. 52.

FIG. 55 is a schematic structural view of the position sensor 330 according to one or more embodiments of the present application.

FIG. 56 is a schematic structural view of the position sensor 330 according to another one or more embodiments of the present application.

FIG. 57 is a side schematic view of the fire extinguishing device according to one or more embodiments of the present application.

FIG. 58 is a schematic structural view of the fire extinguishing device according to one or more embodiments of the present application.

FIG. 59 is a schematic view of the connection between the stator 800, the rotor 900, and the outer housing 930 in the fire extinguishing device shown in FIG. 58.

FIG. 60 is a schematic top view of the stator 800 and the rotor 900 in the fire extinguishing device shown in FIG. 59.

FIG. 61 is a cross-sectional view taken along line I-I in FIG. 60.

FIG. 62 is a schematic structural view of the top cover 830 according to one or more embodiments of the present application.

FIG. 63 is a schematic view of the internal structure of the fire extinguishing device shown in FIG. 58.

### LIST OF REFERENCE NUMERALS

100, connecting pipe; 110, first sealing structure; 111, first sealing groove; 112, first sealing ring; 120, second sealing structure; 121, second sealing groove; 122, second sealing ring; 130, connecting plate; 140, mounting plane; 150, control circuit board; 151, fire sensor; 152, first proximity switch; 153, water inlet pipe; 154, solenoid valve; 200, insertion pipe; 210, groove; 220, mounting hole; 230, bolt; 240, locking hole; 250, synchronous rotation ring; 300, rotating assembly; 310, rotary drive source; 311, driving member; 320, speed reducer; 321, housing; 322, receiving shaft; 324, output shaft; 325, intermediate shaft; 326, first transmission member; 327, second transmission member; 330, position sensor; 331, plug-in hole; 332, rotating shaft; 333, synchronous gear; 334, limiting block; 335, connecting frame; 400, first space; 500, second space; 600, limiting member; 620, connecting portion; 630, first blocking piece; 631, elastic member; 640, support portion; 641, communication groove; 650, first communication hole; 660, second blocking piece; 670, first limiting portion; 671, slot; 672, insertion block; 673, elastic bushing; 674, locking member; 675, limiting hole; 676, fixing member; 677, clearance hole; 680, second limiting portion; 690, second communication hole; 700, spray nozzle; 800, stator; 810, coil winding; 820, medium channel; 830, top cover; 831, limiting block; 840, retaining ring; 900, rotor; 910, mounting plate; 920, connecting post; 921, proximity block; 922, second proximity switch; 923, third proximity switch; 930, outer housing; 940, cover; 950, first bearing; 960, second bearing.

### DETAILED DESCRIPTION

The following describes the disclosure in detail with reference to the accompanying drawings and specific embodiments. In the following description, numerous specific details are set forth in order to provide a thorough understanding of the present disclosure. However, the invention can be implemented in many other ways different from those described herein, and a person skilled in the art may make similar generalizations without departing from the spirit of the present invention; therefore, the present invention is not limited by the specific embodiments disclosed below.

The fluid ejection mechanism and the fire extinguishing device thereof of the present application may be applied to extinguishing fires in their early stage, and of course may also be used in other similar application scenarios. The fluid ejection mechanism and the fire extinguishing device are described in detail below.

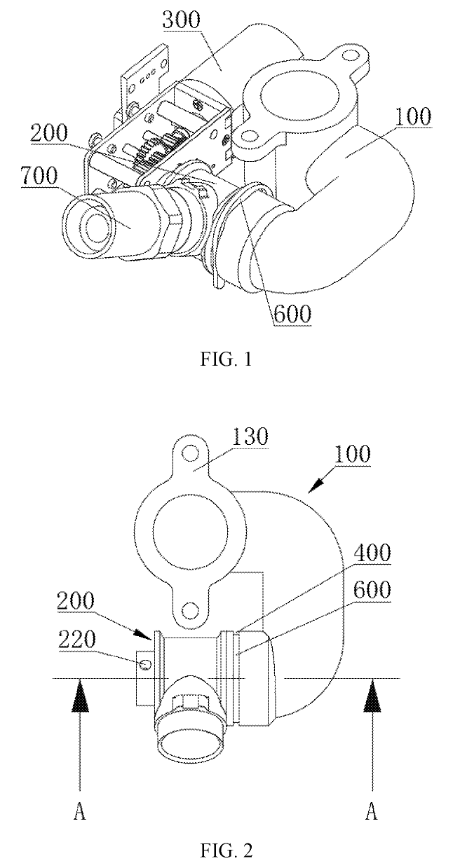

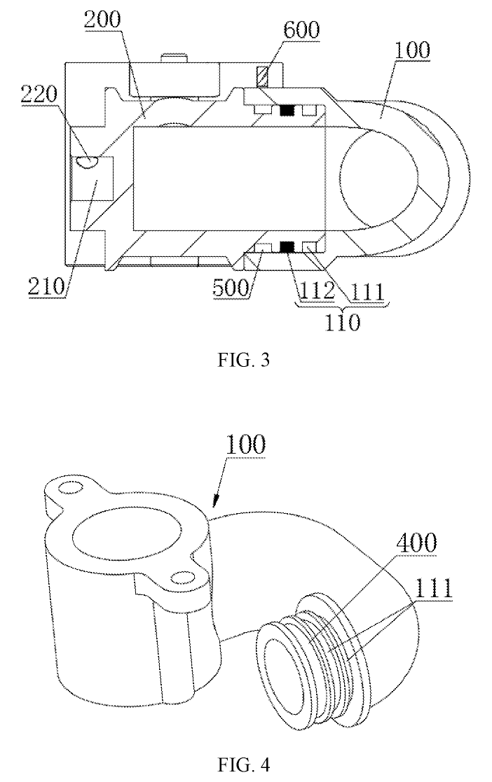

Referring to FIGS. 1-3, there is shown a schematic structural view of a fluid ejection mechanism according to one or more embodiments of the present application. The fluid ejection mechanism includes a connecting pipe 100, an insertion pipe 200 inserted into an end of the connecting pipe 100, a rotating assembly 300 drivingly connected to the insertion pipe 200, and a spray nozzle 700 fixedly mounted on the insertion pipe 200 and in communication with the interior of the insertion pipe 200; wherein the insertion pipe 200 and the connecting pipe 100 are capable of rotating relative to each other circumferentially at the insertion location, the spray nozzle 700 is capable of swinging synchronously with the rotation of the insertion pipe 200, a first space 400 is provided at the end of the connecting pipe 100, and a second space 500 corresponding to the first space 400 is provided at the end of the insertion pipe 200; and the fluid ejection mechanism further includes a limiting member 600 inserted into the first space 400 and the second space 500.

In one or more embodiments of the present application, by inserting the connecting pipe 100 into the insertion pipe 200, the end of the connecting pipe 100 and the end of the insertion pipe 200 are brought into contact between their inner and outer walls, thereby providing the conditions for the first space 400 and the second space 500 to correspond and communicate with each other, while simultaneously providing mutual radial limiting between the connecting pipe 100 and the insertion pipe 200 so that the connecting pipe 100 and the insertion pipe 200 can only move circumferentially or axially relative to each other. By providing the rotating assembly 300 as a power source component, the insertion pipe 200 is driven to rotate about its central axis. By providing the spray nozzle 700, the fluid within the insertion pipe 200, which may for example be tap water, is ejected; under the action of rotation of the insertion pipe 200, the spray nozzle 700 rotates synchronously with the insertion pipe 200, adjusting the ejection angle of the fluid so that the fluid is directionally sprayed to a target location. By inserting the limiting member 600 into the first space 400 and the second space 500, the first space 400 and the second space 500 are kept in mutual communication, thereby achieving axial limiting between the connecting pipe 100 and the insertion pipe 200; under the cooperating engagement of the connecting pipe 100 and the insertion pipe 200, the connecting pipe 100 and the insertion pipe 200 can only rotate circumferentially relative to each other.

In addition, a first sealing structure 110 is provided between the connecting pipe 100 and the insertion pipe 200; the first sealing structure includes a first sealing groove 111 and a first sealing ring 112 mounted in the first sealing groove 111; wherein the first sealing groove 111 is provided on the peripheral surface of the portion where the connecting pipe 100 and the insertion pipe 200 are inserted into each other. By means of the first sealing ring 112 filling the gap at the peripheral surface of the insertion portion between the connecting pipe 100 and the insertion pipe 200, the sealing performance at the insertion location between the connecting pipe 100 and the insertion pipe 200 is improved, avoiding leakage of fluid from the insertion location between the connecting pipe 100 and the insertion pipe 200.

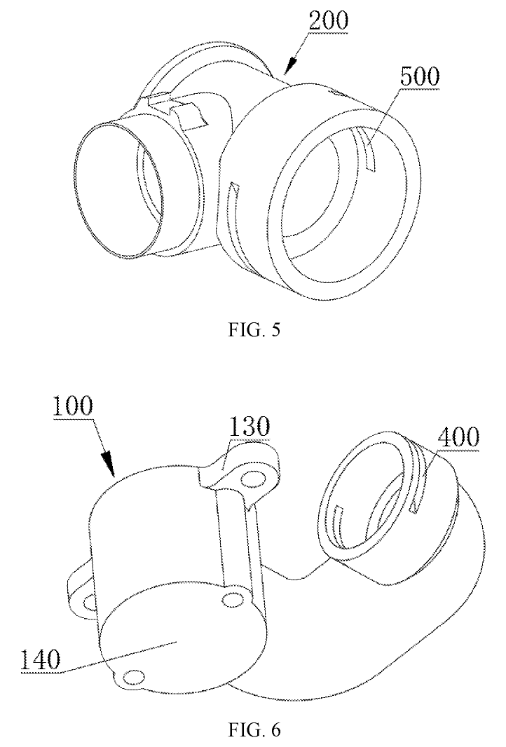

Referring to FIGS. 1, 4, and 5, in one or more embodiments of the present application, the first space 400 is an annular groove provided on the outer peripheral surface of the end of the connecting pipe 100 and extending circumferentially along the end of the connecting pipe 100; the second space 500 is an annular hole provided at the end of the insertion pipe 200 and extending circumferentially along the end of the insertion pipe 200.

In one or more embodiments of the present application, the end of the connecting pipe 100 is inserted into the end of the insertion pipe 200; therefore, the first space 400 is configured as an annular groove to ensure that the limiting member 600 can rotate along the first space 400, and the second space 500 is configured as an annular hole to ensure that, when the limiting member 600 is inserted into the first space 400 and the second space 500, the first space 400 and the second space 500 can be kept in a state of communication, so that the connecting pipe 100 and the insertion pipe 200 can maintain axial positional limiting while allowing the insertion pipe 200 to drive the limiting member 600, via the annular hole, to rotate circumferentially in synchronization, while at the same time preventing the insertion pipe 200 from axially disengaging from the connecting pipe 100 during rotation, thereby ensuring the stability of the pipeline connection and the smoothness of the rotational adjustment, and avoiding leakage due to detachment during fluid delivery.

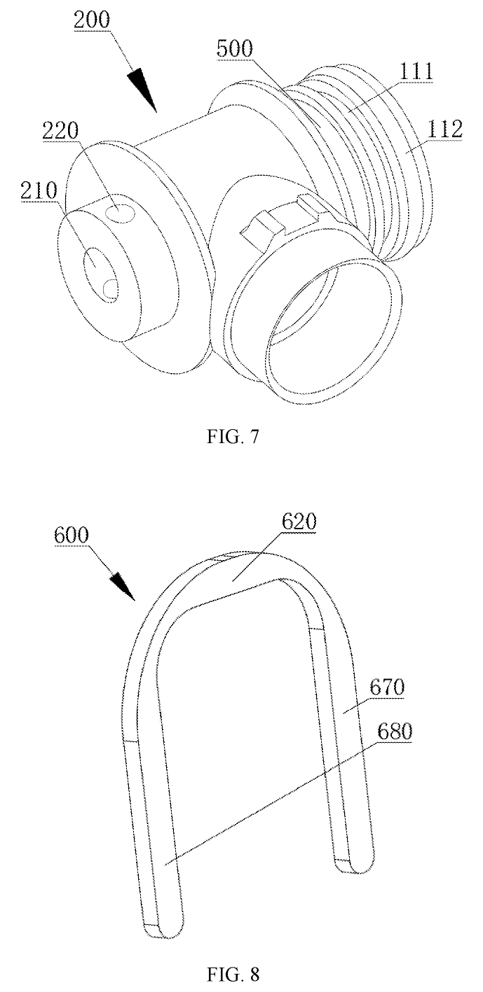

Referring to FIGS. 6 and 7, in one or more embodiments of the present application, the first space 400 is an annular hole provided at the end of the connecting pipe 100 and extending circumferentially along the end of the connecting pipe 100; the second space 500 is an annular groove provided on the outer peripheral surface of the end of the insertion pipe 200 and extending circumferentially along the end of the insertion pipe 200; the end of the insertion pipe 200 remote from the connecting pipe 100 is provided with a recess 210 and a mounting hole 220; wherein the recess 210 is used for insertion engagement with the rotating assembly 300, and the mounting hole 220 is used to provide clearance for a bolt, so that the bolt can connect the rotating assembly 300 to the insertion pipe 200; the bottom of the connecting pipe 100 is provided with a mounting plane 140.

In one or more embodiments of the present application, the end of the insertion pipe 200 is inserted into the end of the connecting pipe 100; therefore, the second space 500 is configured as an annular groove to ensure that the limiting member 600 is inserted and confined within the first space 400, and the first space 400 is configured as an annular hole to ensure that, when the limiting member 600 is inserted into the first space 400 and the second space 500, the first space 400 and the second space 500 can be kept in a state of communication, so that the connecting pipe 100 and the insertion pipe 200 can maintain axial positional limiting while allowing the insertion pipe 200 to rotate about its central axis relative to the limiting member 600, while at the same time preventing the insertion pipe 200 from axially disengaging from the connecting pipe 100 during rotation, thereby ensuring the stability of the pipeline connection and the smoothness of the rotational adjustment, and avoiding leakage due to detachment during fluid delivery.

Referring to FIG. 8, in one or more embodiments of the present application, the limiting member 600 includes a first limiting portion 670 and a second limiting portion 680 respectively located on the two radial sides of the connecting pipe 100, and a connecting portion 620 connecting the first limiting portion 670 and the second limiting portion 680 in the radial direction of the connecting pipe 100; wherein the first limiting portion 670, the second limiting portion 680, and the connecting portion 620 are integrally formed, and the first limiting portion 670 and the second limiting portion 680 have the same structure.

In one or more embodiments of the present application, by providing the first limiting portion 670 and the second limiting portion 680 for insertion into the first space 400 and the second space 500 at positions on the two radial sides of the connecting pipe 100, and connecting the first limiting portion 670 and the second limiting portion 680 by means of the connecting portion 620, the first limiting portion 670 and the second limiting portion 680 are clamped tightly within the first space 400 and the second space 500. In this limiting member 600, the first limiting portion 670 and the second limiting portion 680 may each be made of an elastic material, or the two limiting portions may be made of an elastic material; and of course the entire limiting member 600 may be made of an elastic material, so that the first limiting portion 670 and the second limiting portion 680 can be clamped tightly within the first space 400 and the second space 500, ensuring that the limiting member 600 does not separate from the connecting pipe 100 or the insertion pipe 200 during use.

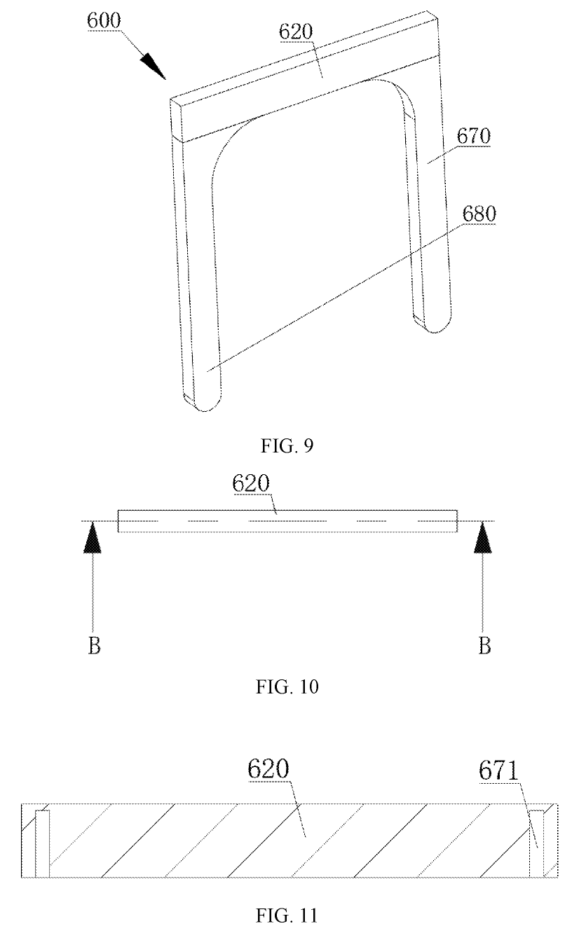

Referring to FIGS. 9-12, in one or more embodiments of the present application, the first limiting portion 670 and the second limiting portion 680 are each detachably connected to the connecting portion 620; the connecting portion 620 is provided with a slot 671, and the first limiting portion 670 and the second limiting portion 680 are each provided with an insertion block 672 adapted to fit the slot 671.

In one or more embodiments of the present application, by providing the slot 671 in cooperation with the insertion block 672 to achieve an insertion-type installation of the limiting member 600, the limiting portions and the connecting portion 620 can be conveniently disassembled and replaced; when a limiting portion exhibits elastic fatigue or wear after prolonged use, the corresponding component can be individually replaced without replacing the entire limiting member 600, thereby reducing maintenance costs, while also enabling adaptation to connecting pipes 100 and insertion pipes 200 of different specifications, thereby increasing the scope of applicability of the limiting member 600.

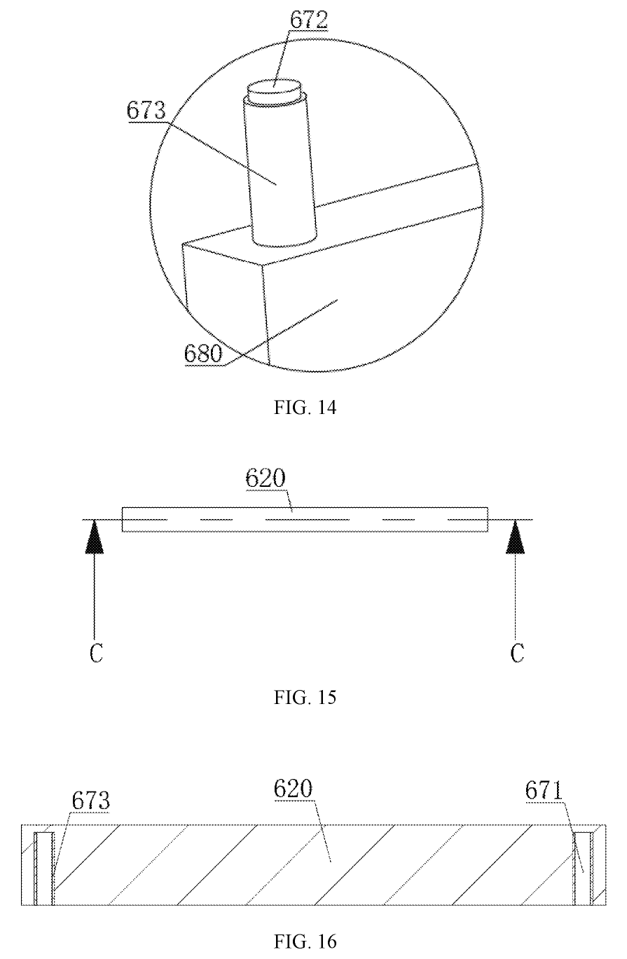

Referring to FIGS. 13 and 14, in one or more embodiments of the present application, an elastic bushing 673 is mounted by adhesive bonding to the insertion block 672 of the first limiting portion 670 and the second limiting portion 680, and the insertion block 672 is in interference fit, via the elastic bushing 673, with the slot 671 of the connecting portion 620 shown in FIGS. 10 and 11 described above, thereby ensuring the connection strength between the insertion block 672 and the slot 671 and avoiding separation of the limiting portions from the connecting portion 620 during use.

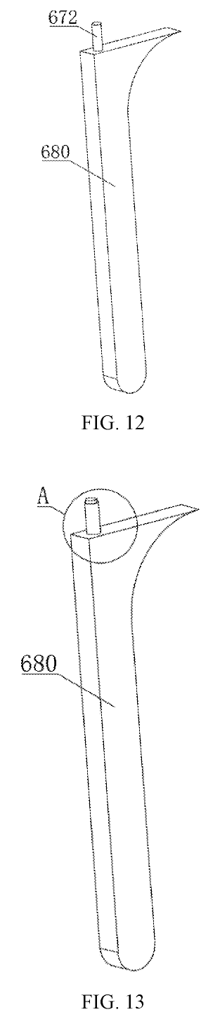

Referring to FIGS. 15 and 16, in one or more embodiments of the present application, an elastic bushing 673 is mounted by adhesive bonding within the slot 671 of the connecting portion 620, and this connecting portion 620 is placed in interference fit with the second limiting portion 680 shown in FIG. 12 described above, thereby ensuring the connection strength between the insertion block 672 and the slot 671 and avoiding separation of the limiting portions from the connecting portion 620 during use.

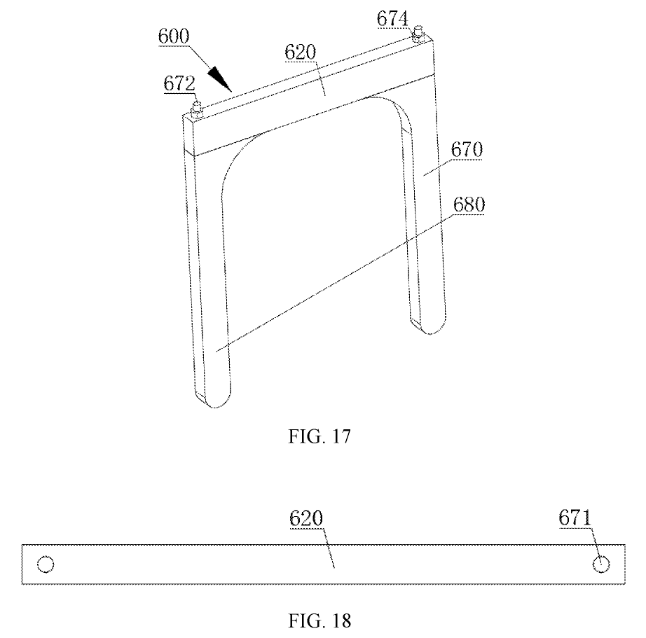

Referring to FIGS. 17 and 18, in one or more embodiments of the present application, the insertion block 672 is fitted with a locking member 674, the locking member 674 being a lock nut, such that the locking member 674 engages the insertion block 672 by a threaded connection; after the insertion block 672 is inserted into the slot 671 and passes through the slot 671, the locking member 674 locks and limits the position of the insertion block 672, preventing the locking member 674 from separating from the slot 671.

In one or more embodiments of the present application, by providing the locking member 674, the connecting portion 620 and the limiting portions can be conveniently disassembled and assembled while ensuring the connection strength between the connecting portion 620 and the first limiting portion 670 and the second limiting portion 680.

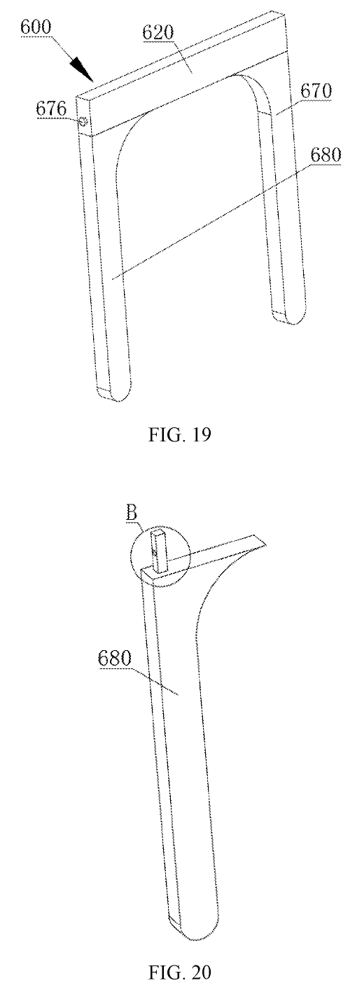

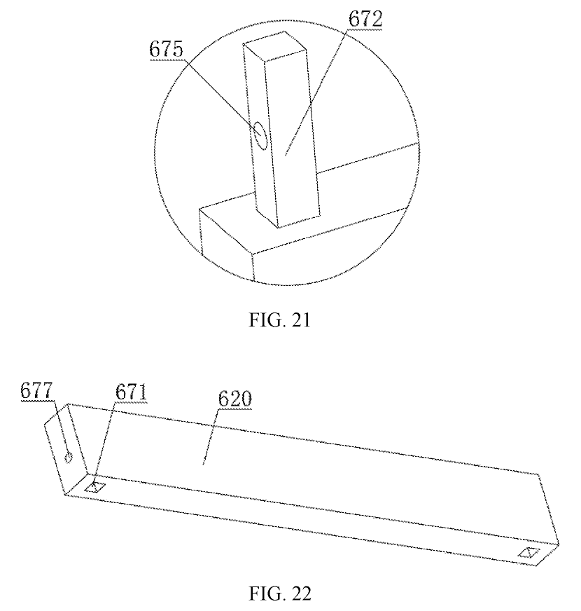

Referring to FIGS. 19-22, in one or more embodiments of the present application, the insertion block 672 is detachably fitted with a fixing member 676, the fixing member 676 fixing the connecting portion 620 to the first limiting portion 670 and to the second limiting portion 680; wherein the insertion block 672 has a limiting hole 675, and the side wall of the connecting portion 620 is provided with a clearance hole 677 communicating with the slot 671, and the fixing member 676 may, for example, be a bolt or a thumb screw.

In one or more embodiments of the present application, after the first limiting portion 670 and the second limiting portion 680 are inserted into the slot 671 of the connecting portion 620, the limiting hole 675 of the first limiting portion 670 and the second limiting portion 680 communicates with the clearance hole 677 of the slot 671, at which point the fixing member 676 can be passed through the clearance hole 677 and the limiting hole 675 to connect the first limiting portion 670 and the second limiting portion 680 to the connecting portion 620.

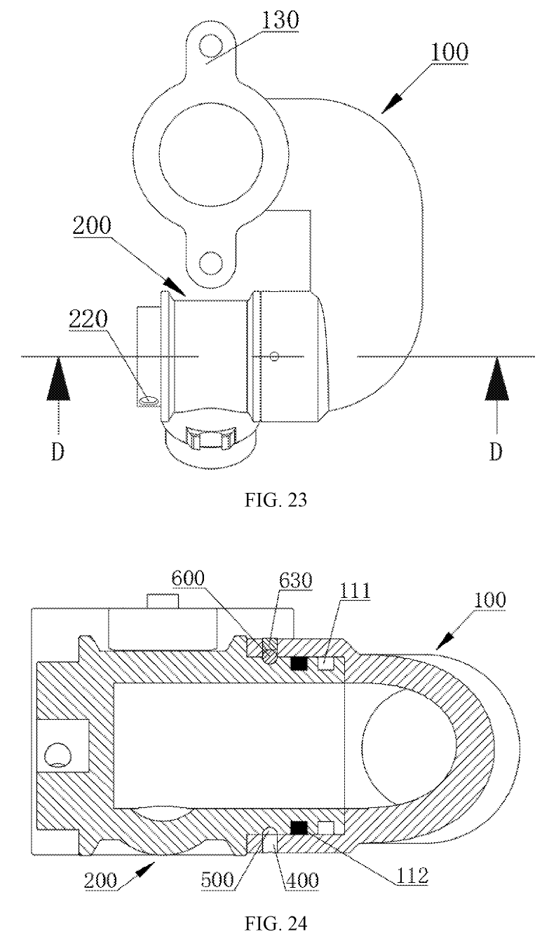

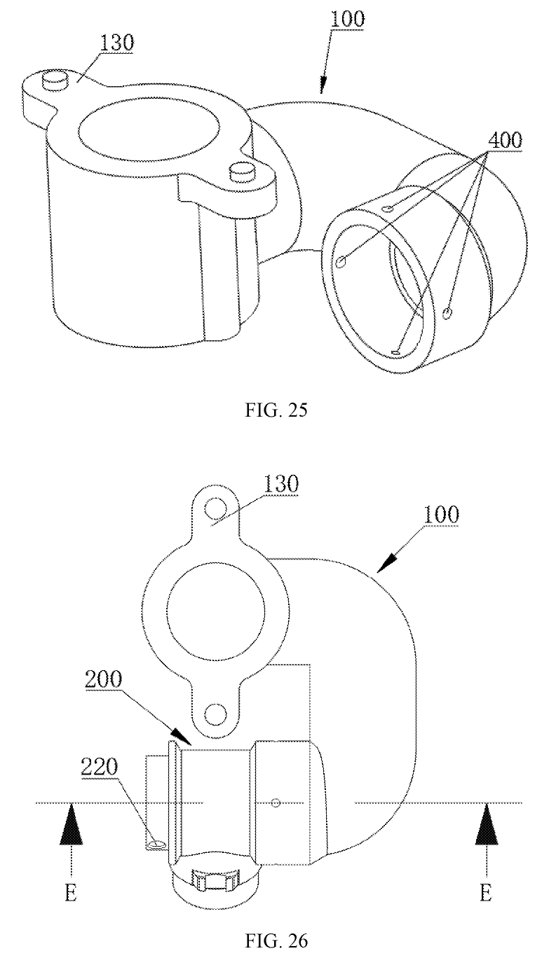

Referring to FIGS. 23-25, in one or more embodiments of the present application, the first space 400 is a through hole extending radially at the end of the connecting pipe 100; the second space 500 is an annular groove extending circumferentially on the outer peripheral surface of the end of the insertion pipe 200; wherein the limiting member 600 is a ball and is simultaneously embedded in both the first space 400 and the second space 500. By inserting the insertion pipe 200 of FIG. 7 described above into the connecting pipe 100 of FIG. 25, a schematic top view of the connection relationship between the connecting pipe 100 and the insertion pipe 200 is obtained, i.e., FIG. 23.

In one or more embodiments of the present application, by configuring the first space 400 as a through hole, clearance is provided for the limiting member 600, providing a passage condition for the limiting member 600 to be embedded in the first space 400 and the second space 500; by configuring the second space 500 as an annular groove, the limiting member 600 can move within the second space 500, ensuring that the insertion pipe 200 can rotate relative to the connecting pipe 100 about its central axis. By configuring the limiting member 600 as a ball, the limiting member 600 can rotate within the first space 400 and the second space 500, while simultaneously providing axial limiting for the first space 400 and the second space 500, preventing separation of the connecting pipe 100 and the insertion pipe 200.

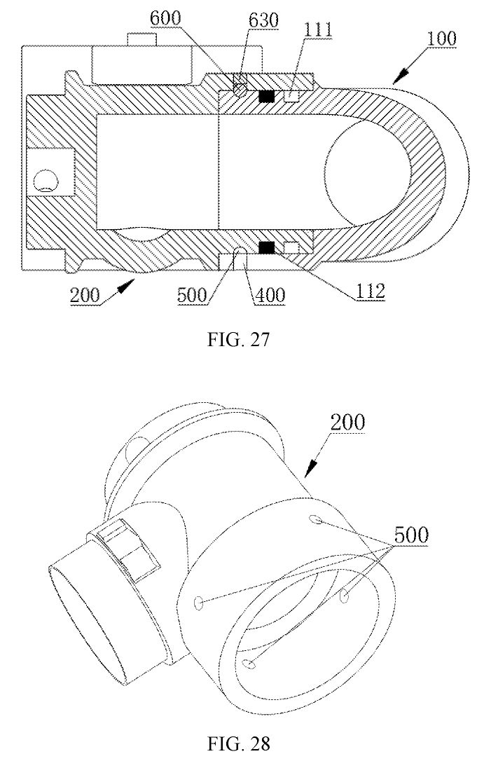

Referring to FIGS. 26-28, in one or more embodiments of the present application, the second space 500 is a through hole extending radially at the end of the insertion pipe 200, and the first space 400 is an annular groove extending circumferentially on the outer peripheral surface of the end of the connecting pipe 100, the connecting pipe 100 provided with this first space 400 being the same as that of the insertion pipe 200 shown in FIG. 4 above; wherein the limiting member 600 is a ball and is simultaneously embedded in both the first space 400 and the second space 500. By inserting the connecting pipe 100 of FIG. 4 into the insertion pipe 200 of FIG. 28, a schematic top view of the connection relationship between the connecting pipe 100 and the insertion pipe 200 as shown in FIG. 26 is obtained.

In one or more embodiments of the present application, by configuring the second space 500 as a through hole, clearance is provided for the limiting member 600, providing a passage condition for the limiting member 600 to be embedded in the first space 400 and the second space 500; by configuring the first space 400 as an annular groove, the limiting member 600 can move within the second space 500, ensuring that the insertion pipe 200 can rotate relative to the connecting pipe 100 about its central axis. By configuring the limiting member 600 as a ball, the limiting member 600 can rotate within the first space 400 and the second space 500, while simultaneously providing axial limiting for the first space 400 and the second space 500, preventing separation of the connecting pipe 100 and the insertion pipe 200.

In addition, in one or more embodiments of the present application, a first blocking piece 630 is fixedly mounted by interference fit at the opening of the through hole of the first space 400 near the outer peripheral surface of the connecting pipe 100, the first blocking piece 630 being made of an elastically deformable material, such as rubber; of course, when the second space 500 is a through hole, a first blocking piece 630 may likewise be fixedly mounted by interference fit at the opening of the second space 500 near the outer peripheral surface of the insertion pipe 200.

In one or more embodiments of the present application, the first blocking piece 630 is mounted at the opening of the through hole, since the through hole serves as the installation passage for the spherical limiting member 600; therefore, after being sealed by the first blocking piece 630, the limiting member 600 cannot be removed through the installation passage, ensuring that the limiting member 600 remains embedded in the first space 400 and the second space 500, providing axial limiting between the connecting pipe 100 and the insertion pipe 200 while still permitting the connecting pipe 100 and the insertion pipe 200 to rotate circumferentially relative to each other.

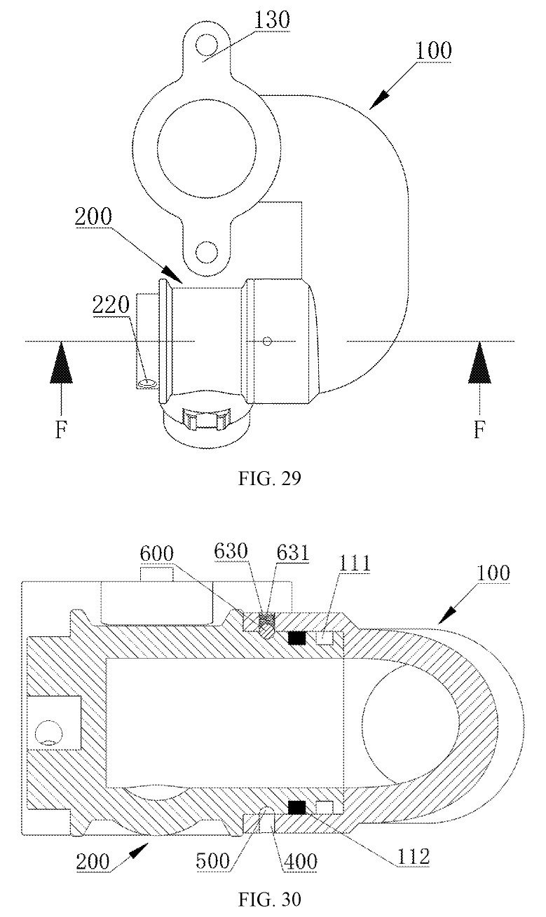

Referring to FIGS. 29-30, in one or more embodiments of the present application, an elastic member 631 is provided between the first blocking piece 630 and the limiting member 600 and is compressed by both; wherein the elastic member 631 is a spring.

In one or more embodiments of the present application, by providing the elastic member 631, when the limiting member 600 rolls within the annular groove, even if impurities are present within the annular groove and interfere with the limiting member 600, the limiting member 600 can compress the elastic member 631 to pass over the impurities, thereby avoiding damage to the rotary drive source 310 caused by interference and effectively protecting the rotary drive source 310.

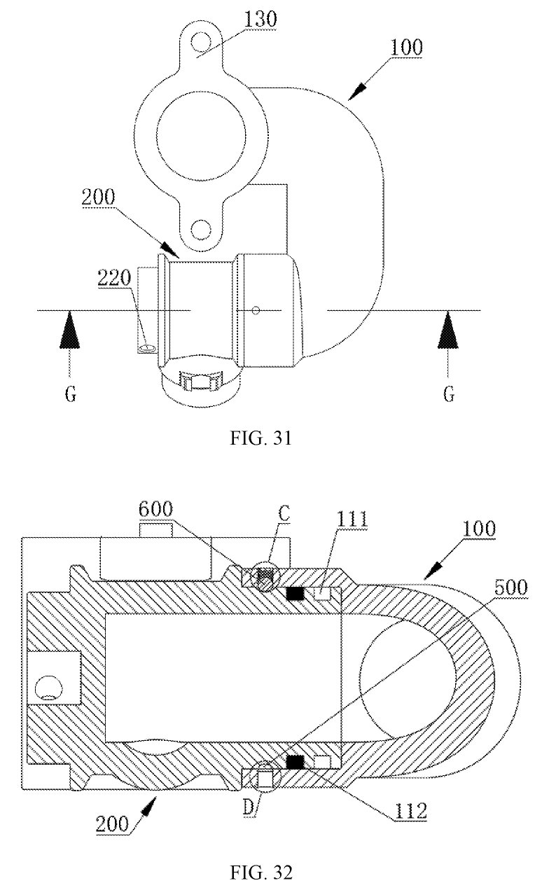

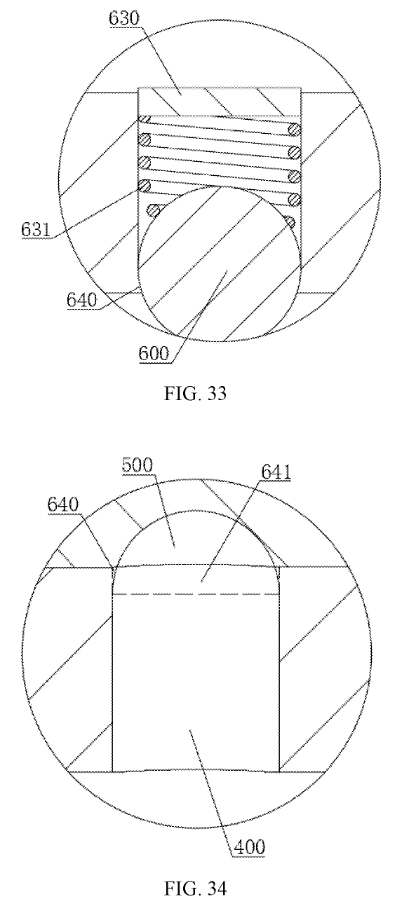

Referring to FIGS. 31-34, in one or more embodiments of the present application, a support portion 640 is provided at the opening of the through hole of the first space 400 near the inner peripheral surface of the connecting pipe 100, the support portion 640 having a reduced bore diameter; wherein the reduced bore diameter of the support portion 640 forms a communication groove 641 that communicates with, and is arranged concentrically with, the first space 400, thereby placing the first space 400 in communication with the second space; the limiting member 600 is spherical in shape.

In one or more embodiments of the present application, by providing the support portion 640, the limiting member 600 is supported, preventing the limiting member 600 from falling directly out of the first space 400, so that the limiting member 600 can be pre-installed, shortening the installation time for the connecting pipe 100 and the insertion pipe 200 and improving installation efficiency; by providing the communication groove 641, clearance is provided for the limiting member 600, ensuring that the limiting member 600 can connect the first space 400 and the second space 500 in a limiting manner. Of course, when the second space 500 is a through hole and the first space 400 is an annular groove, a support portion 640 can likewise be provided at the opening of the through hole of the second space 500 near the inner peripheral surface of the insertion pipe 200, for preventing the limiting member 600 from falling out of the second space 500.

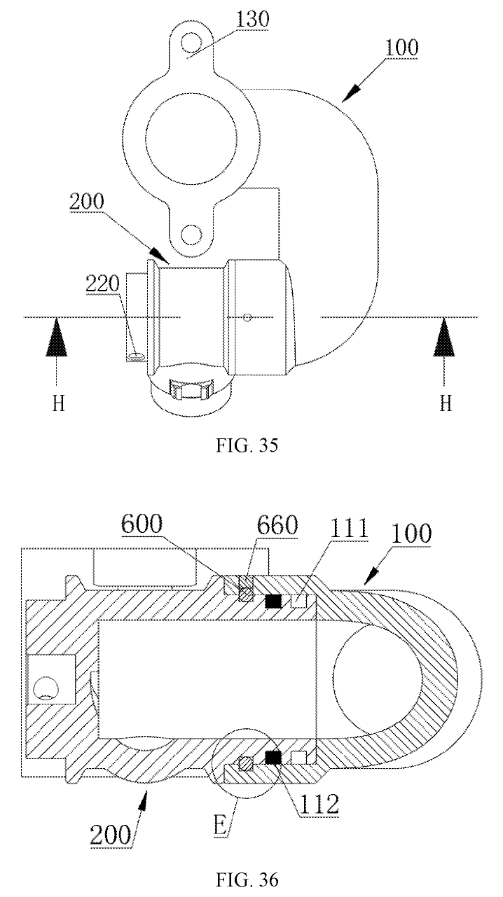

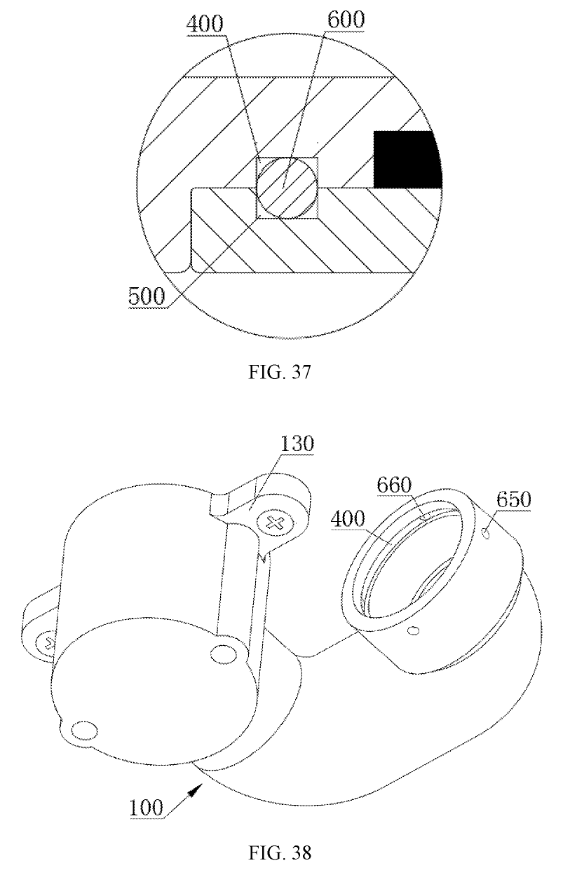

Referring to FIGS. 35-38, in one or more embodiments of the present application, the first space 400 is an annular groove extending circumferentially on the inner peripheral surface of the end of the connecting pipe 100; the second space 500 is an annular groove extending circumferentially on the outer peripheral surface of the end of the insertion pipe 200; the limiting member 600 is a ball and is simultaneously embedded in the first space 400 and the second space 500, thereby achieving axial positional fixation between the connecting pipe 100 and the insertion pipe 200.

It should be noted that the top view of the connecting pipe 100 and the insertion pipe 200 in their inserted state shown in FIG. 35 is obtained by inserting the connecting pipe 100 of FIG. 38 into the insertion pipe 200 of FIG. 7.

In one or more embodiments of the present application, by configuring both the first space 400 and the second space 500 as annular grooves, the volume of space in which the first space 400 and the second space 500 communicate with each other is increased, thereby effectively increasing the number of limiting members 600 that can be used, thereby increasing the connection strength between the insertion pipe 200 and the connecting pipe 100; in addition, because the number of limiting members 600 is increased, the load borne by each limiting member 600 is evenly distributed and reduced, which can effectively reduce the size of each limiting member 600, thereby reducing the space required for installing the limiting members 600, i.e., reducing the size of the first space 400 and the second space 500, so that the inner diameter of the connecting pipe 100 and the insertion pipe 200 can be increased, or the outer diameter reduced, thereby reducing the overall volume.

In addition, when the first space 400 is an annular groove extending circumferentially on the inner peripheral surface of the end of the connecting pipe 100, the connecting pipe 100 is provided with a radially extending first communication hole 650 communicating with the first space 400, the limiting member 600 entering the first space 400 and the second space 500 through the first communication hole 650, and a second blocking piece 660 is mounted at the opening of the first communication hole 650, thereby effectively preventing the limiting member 600 from sliding out of the first communication hole 650.

In one or more embodiments of the present application, the first communication hole 650 provides an installation passage for the spherical limiting member 600, allowing the limiting member 600 to be embedded in the first space 400 and the second space 500, providing axial limiting between the connecting pipe 100 and the insertion pipe 200 while ensuring that the connecting pipe 100 and the insertion pipe 200 can rotate circumferentially relative to each other; by using the limiting member 600 to seal the first communication hole 650, the spherical limiting member 600 is effectively prevented from disengaging from the first communication hole 650, ensuring that the connecting pipe 100 and the insertion pipe 200 can undergo normal relative circumferential rotation.

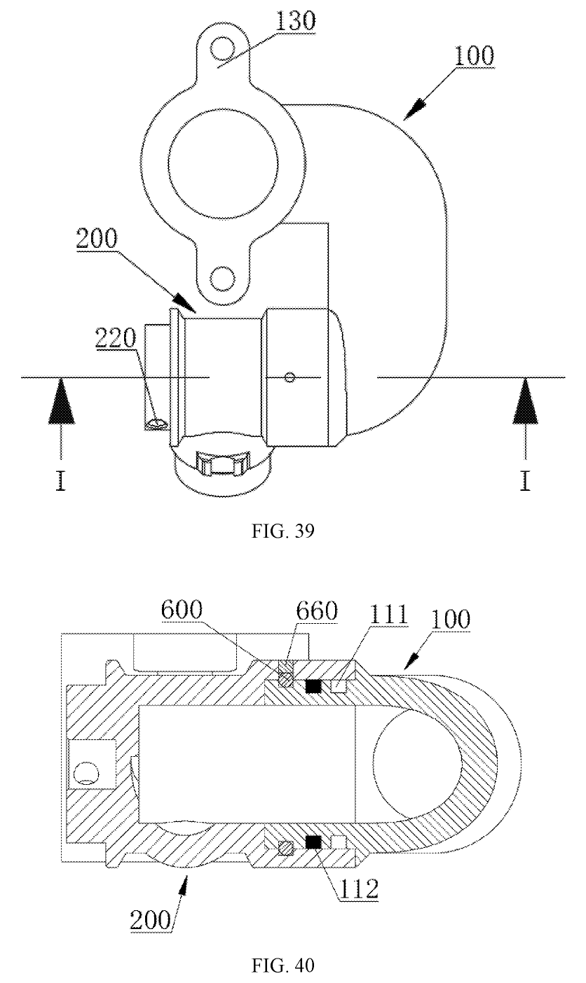

Referring to FIGS. 39-41, in one or more embodiments of the present application, the first space 400 is an annular groove extending circumferentially on the outer peripheral surface of the end of the connecting pipe 100; the second space 500 is an annular groove extending circumferentially on the inner peripheral surface of the end of the insertion pipe 200; wherein the limiting member 600 is a ball and is simultaneously embedded in the first space 400 and the second space 500 so as to achieve axial positional fixation between the connecting pipe 100 and the insertion pipe 200.

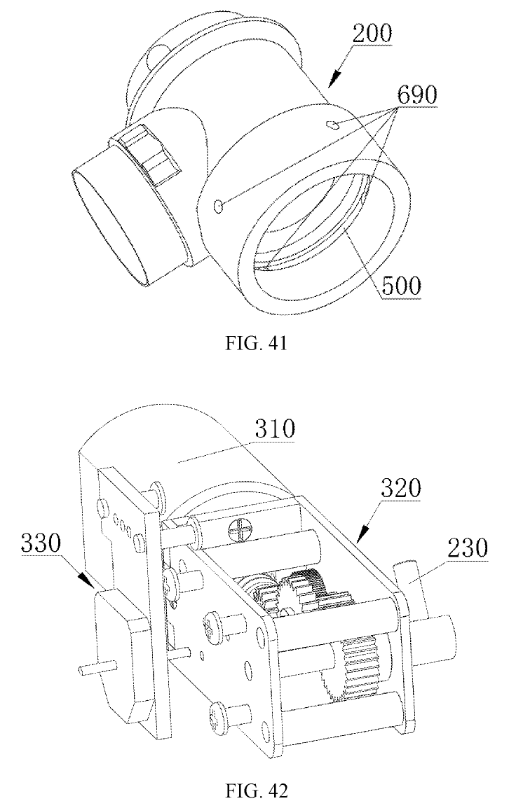

It should be noted that the top view of the connecting pipe 100 and the insertion pipe 200 in their inserted state shown in FIG. 39 is obtained by inserting the insertion pipe 200 of FIG. 41 into the connecting pipe 100 of FIG. 4.

In one or more embodiments of the present application, by configuring both the first space 400 and the second space 500 as annular grooves, the volume of space in which the first space 400 and the second space 500 communicate with each other is increased, thereby effectively increasing the number of limiting members 600 that can be used, thereby increasing the connection strength between the insertion pipe 200 and the connecting pipe 100; in addition, because the number of limiting members 600 is increased, the load borne by each limiting member 600 is evenly distributed and reduced, which can effectively reduce the size of each limiting member 600, thereby reducing the space required for installing the limiting members 600, i.e., reducing the size of the first space 400 and the second space 500, so that the inner diameter of the connecting pipe 100 and the insertion pipe 200 can be increased, or the outer diameter reduced, thereby reducing the overall volume.

In addition, when the second space 500 is an annular groove extending circumferentially on the inner peripheral surface of the end of the insertion pipe 200, the insertion pipe 200 is provided with a radially extending second communication hole 690 communicating with the second space 500. The limiting member 600 enters the first space 400 and the second space 500 through the second communication hole 690. In addition, a second blocking piece 660 may be mounted at the opening of the second communication hole 690, thereby preventing the limiting member 600 from falling out of the second communication hole 690.

In one or more embodiments of the present application, the second communication hole 690 provides an installation passage for the spherical limiting member 600, allowing the limiting member 600 to be embedded in the first space 400 and the second space 500, providing axial limiting between the connecting pipe 100 and the insertion pipe 200 while ensuring that the connecting pipe 100 and the insertion pipe 200 can rotate circumferentially relative to each other; by using the limiting member 600 to seal the second communication hole 690, the spherical limiting member 600 is effectively prevented from disengaging from the second communication hole 690, ensuring that the connecting pipe 100 and the insertion pipe 200 can undergo normal relative circumferential rotation.

Referring to FIG. 42, a speed reducer 320 is connected to the output end of the rotary drive source 310, and a position sensor 330 is connected to the speed reducer 320; wherein the rotary drive source 310 is a motor, the speed reducer 320 is used to reduce the rotational speed output by the rotary drive source 310, and the position sensor 330 is a potentiometer, which may specifically be a rotary potentiometer.

In one or more embodiments of the present application, by providing the rotary drive source 310, power is supplied for the insertion pipe 200 to rotate about its central axis, so that the insertion pipe 200 drives the spray nozzle 700 to rotate, thereby adjusting and controlling the direction of the fluid ejected by the spray nozzle 700.

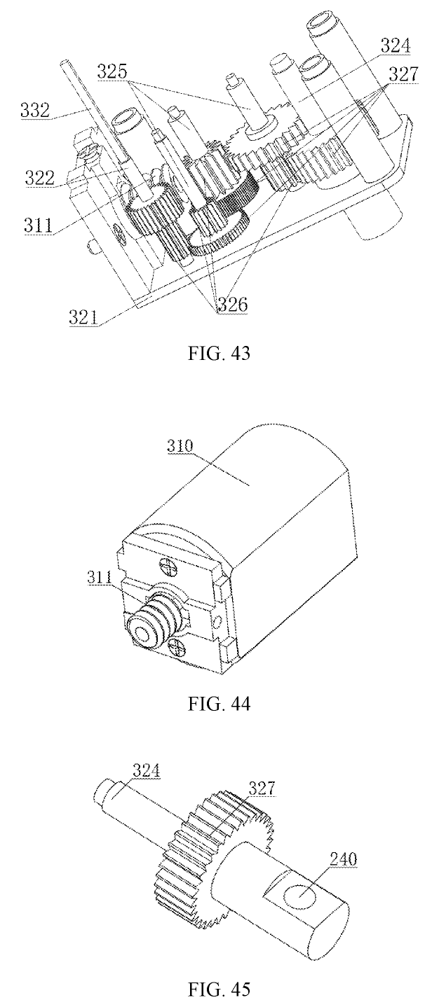

Referring to FIGS. 42-45 and 55, in the embodiments of the present application, a driving member 311 is fitted on the output shaft of the rotary drive source 310. The speed reducer 320 mainly includes a housing 321, a receiving shaft 322, an output shaft 324, and an intermediate shaft 325. The receiving shaft 322 is movably mounted within the housing 321 and is meshed with the driving member 311; the output shaft 324 is movably mounted within the housing 321 and is connected to the end of the insertion pipe 200; and the intermediate shaft 325 is movably mounted within the housing 321 and disposed between the receiving shaft 322 and the output shaft 324.

A first transmission member 326 is fixedly mounted on each of the receiving shaft 322 and the intermediate shaft 325, and a second transmission member 327 is mounted on the output shaft 324. The first transmission member 326 and the second transmission member 327 are both gears, and the two mesh with each other. The number of teeth of each meshing first transmission member 326 is smaller than that of the corresponding second transmission member 327; the number of teeth of the second transmission member 327 on the same intermediate shaft 325 is greater than that of its corresponding first transmission member 326. The receiving shaft 322, the intermediate shaft 325, and the output shaft 324 transmit power through the meshing engagement of the first transmission member 326 and the second transmission member 327. The driving member 311 is a worm gear, and the receiving shaft 322 is a worm. The minimum linear distance between the receiving shaft 322 and the rotary drive source 310 is smaller than the minimum linear distance between the intermediate shaft 325 and the rotary drive source 310; the minimum linear distance between the intermediate shaft 325 and the rotary drive source 310 is smaller than the minimum linear distance between the output shaft 324 and the rotary drive source 310.

In addition, the end of the output shaft 324 inserted into the recess 210 is provided with a mounting hole 220, within which a bolt 230 is tightly mounted. By means of this bolt 230, the end of the insertion pipe 200 is firmly connected to the output shaft 324, thereby ensuring that the rotation of the output shaft 324 can smoothly drive the insertion pipe 200 to rotate about its central axis.

In addition, the position sensor 330 is a potentiometer provided with a plug-in hole 331. The plug-in hole 331 is D-shaped. A rotating shaft 332 is coaxially disposed within the plug-in hole 331, and the central axis of the rotating shaft 332 coincides with the central axis of the receiving shaft 322. The rotating shaft 332 and the receiving shaft 322 are either machined integrally or fixedly connected. The rotating shaft 332 is adapted to fit the plug-in hole 331, such that a cross-sectional profile perpendicular to the length direction of the rotating shaft 332 is D-shaped.

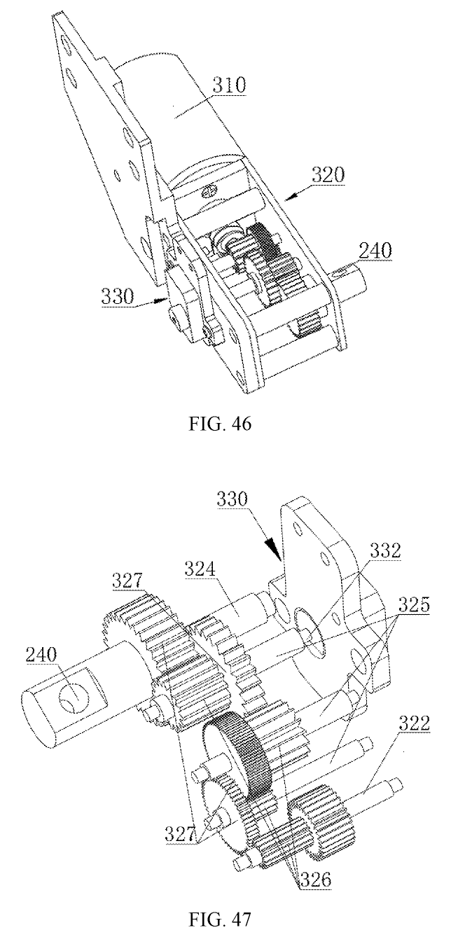

Referring to FIGS. 46, 47, and 55, in one or more embodiments of the present application, the rotating shaft 332 mounted within the plug-in hole 331 of the position sensor 330 is connected to the end of the intermediate shaft 325 so as to rotate synchronously therewith.

By connecting the rotating shaft 332 to the end of the intermediate shaft 325, the position sensor 330 obtains the rotation angle of the spray nozzle 700 via the rotation angle of the intermediate shaft 325; this reduces the number of transmission stages between the detection location and the insertion pipe 200, reducing mechanical losses, so that the angle data of the spray nozzle 700 detected by the position sensor 330 more closely approximates the actual rotation angle of the spray nozzle 700, thereby achieving more precise angular adjustment of the spray nozzle 700.

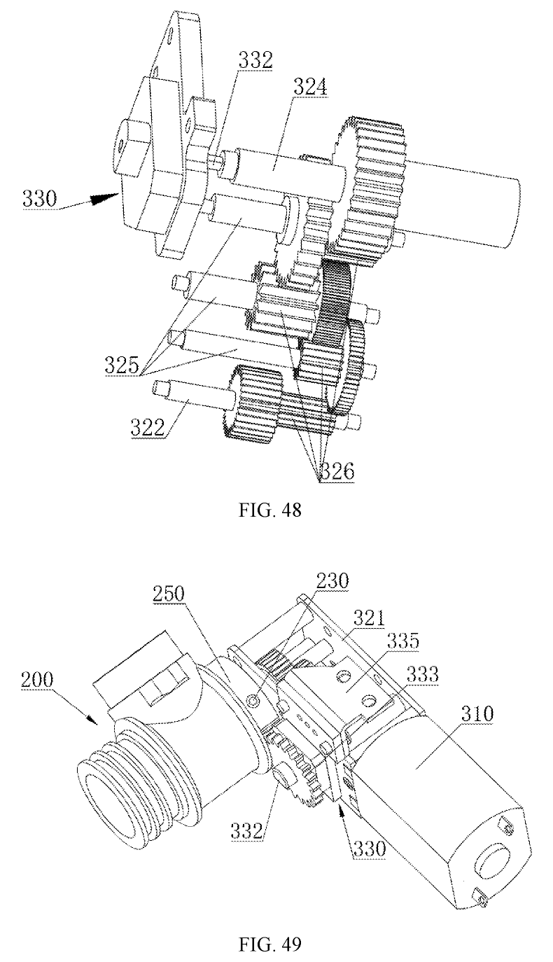

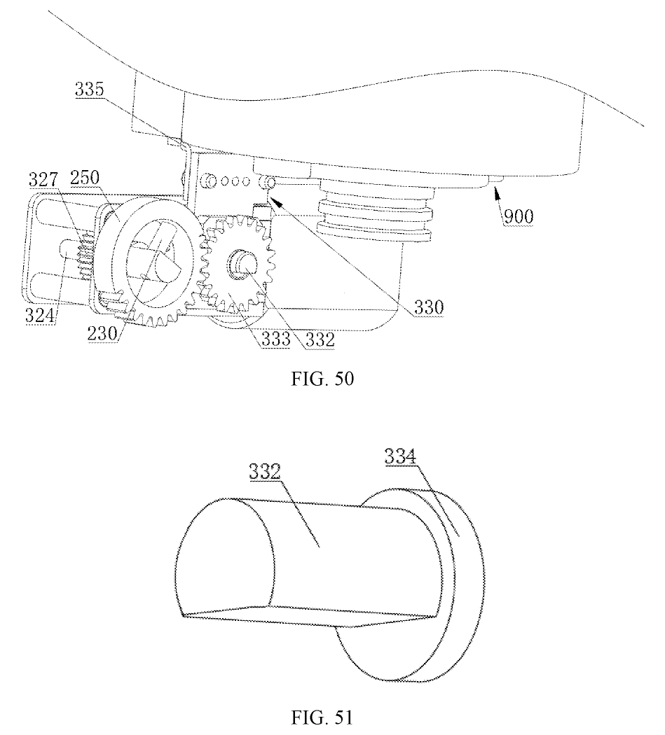

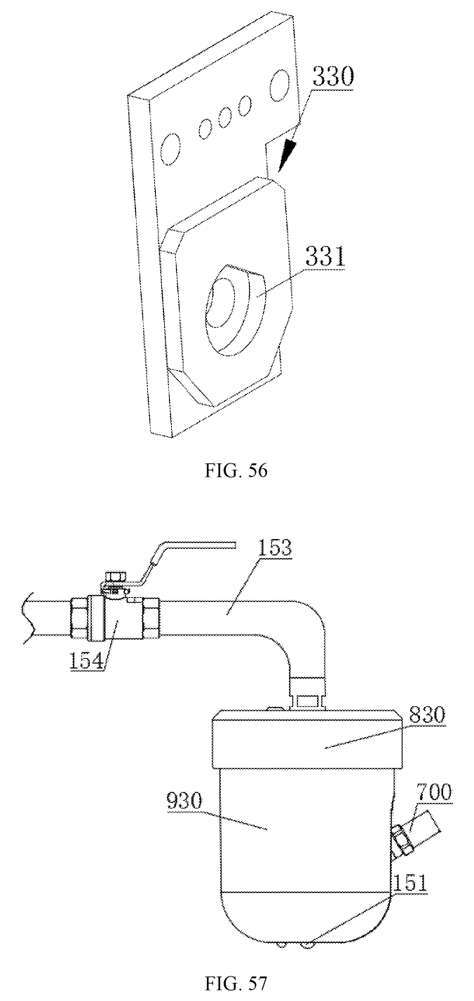

Referring to FIGS. 48-51 and 56, in one or more embodiments of the present application, the end of the insertion pipe 200 remote from the connecting pipe 100 is fitted, by bolts, with a synchronous rotation ring 250, and a synchronous gear 333 is mounted on the rotating shaft 332 within the plug-in hole 331; the synchronous rotation ring 250 is provided with teeth meshing with the synchronous gear 333, such that when the synchronous rotation ring 250 rotates, it drives, via the meshing engagement, the rotating shaft 332 to rotate, thereby obtaining the rotation angle of the insertion pipe 200 and the spray nozzle 700 via rotation of the synchronous gear 333.

It should be particularly noted that the end of the rotating shaft 332 facing the housing 321 is provided with a limiting block 334, by means of which the rotating shaft 332 is effectively prevented from separating from the position sensor 330; the synchronous rotation ring 250 is connected to the output shaft 324 by bolts 230. The position sensor 330 is fitted, by bolts, with a connecting frame 335, which can be fixedly mounted by bolts, and may specifically be mounted on the bottom of the rotor 900 of the fire extinguishing device.

In one or more embodiments of the present application, by causing the synchronous rotation ring 250 to rotate synchronously with the insertion pipe 200, the rotation angle of the synchronous rotation ring 250 can represent the rotation angle of the insertion pipe 200; by meshing the synchronous rotation ring 250 with the synchronous gear 333, the rotation angle of the synchronous rotation ring 250 corresponds to that of the synchronous gear 333 — that is, given the transmission ratio between the synchronous rotation ring 250 and the synchronous gear 333, the rotation angle of the synchronous gear 333 after the synchronous rotation ring 250 rotates a specified angle can be obtained, so that the position sensor 330 can obtain the rotation angle of the insertion pipe 200.

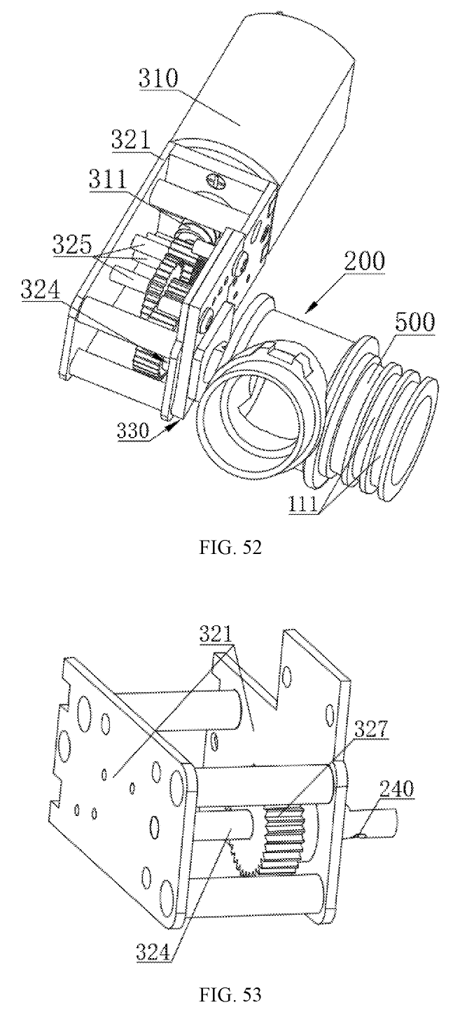

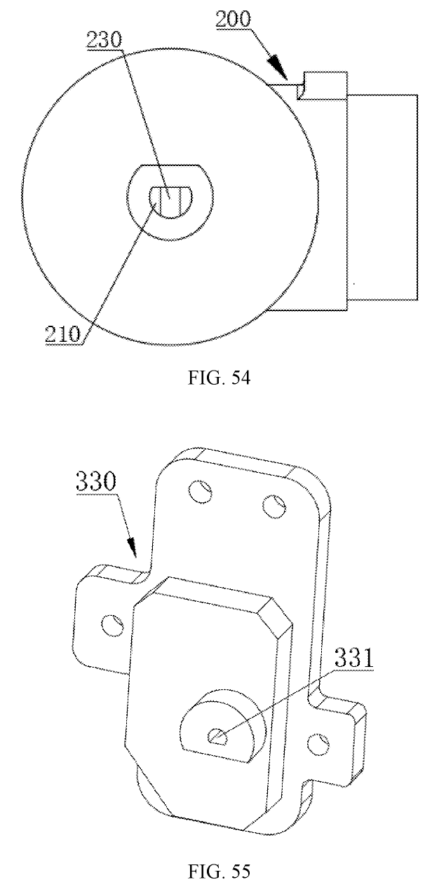

Referring to FIGS. 52-54, in one or more embodiments of the present application, the plug-in hole 331 of the position sensor 330 is adapted to fit the end of the insertion pipe 200, directly sensing the rotation angle of the insertion pipe 200, thereby ensuring the precision of the angular adjustment of the insertion pipe 200, so that the fluid ejected from the spray nozzle 700 can reach the specified location.

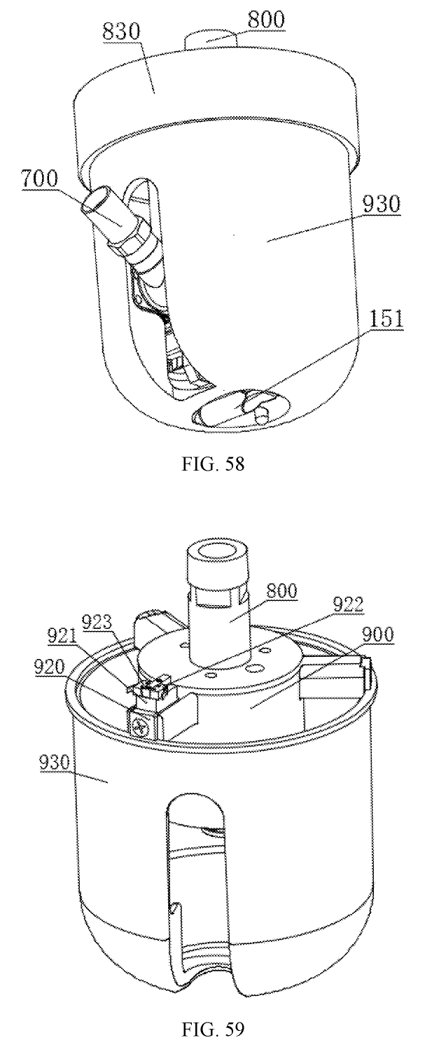

Referring to FIGS. 57 and 58, one or more embodiments of the present application disclose a fire extinguishing device, the fire extinguishing device including a stator 800, a rotor 900 fitted around the exterior of the stator 800 and rotating about the stator 800, a coil winding 810 provided on the stator 800, and a medium channel 820 provided through the stator 800; wherein the medium channel 820 communicates with the connecting pipe 100; a mounting plate 910 is mounted by bolts on the outer wall of the rotor 900, and this mounting plate 910 is connected by bolts to the rotating assembly 300 of the fluid ejection mechanism described above; a cover 940 is mounted at the top of the rotor 900 by interference fit. Of course, the coil winding 810 may alternatively be provided on the rotor 900.

In addition, the rotor 900 is provided with a first bearing 950 and a second bearing 960; inner rings of the first bearing 950 and the second bearing 960 are in tight contact with an outer wall of the stator 800, and outer rings of the first bearing 950 and the second bearing 960 are in interference fit with the rotor 900. Moreover, a retaining ring 840 configured to limit the second bearing 960 is mounted on the outer wall of the stator 800, thereby preventing the occurrence of axial separation between the stator 800 and the rotor 900 caused by instantaneous water flow generated during use. The retaining ring 840 is a C-shaped snap spring. Using the C-shaped snap spring as the retaining ring 840 facilitates assembly and disassembly, and allows for installation after the stator 800 and the rotor 900 are assembled, thereby avoiding interference with the assembly process of the rotor 900 and the stator 800 and ensuring a smooth and efficient assembly process.

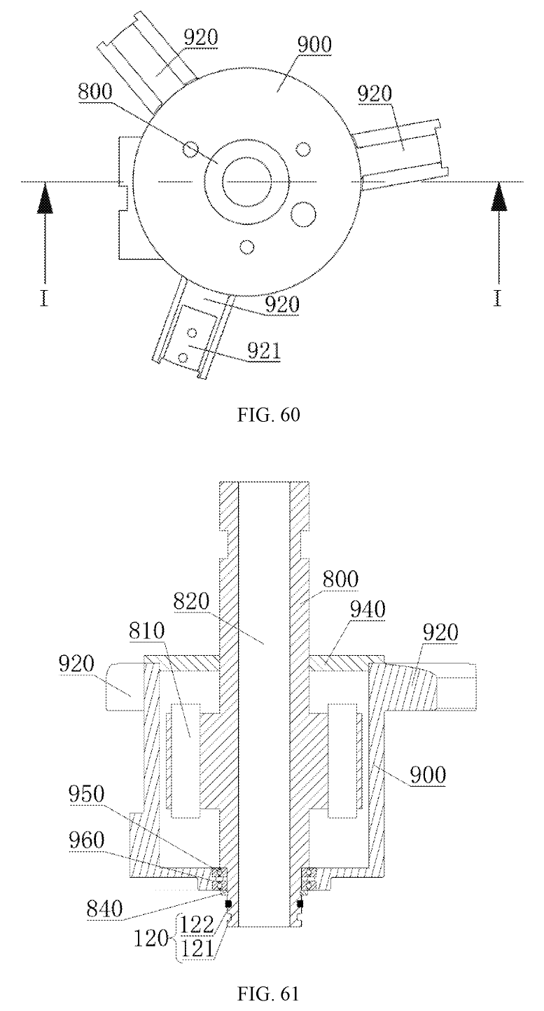

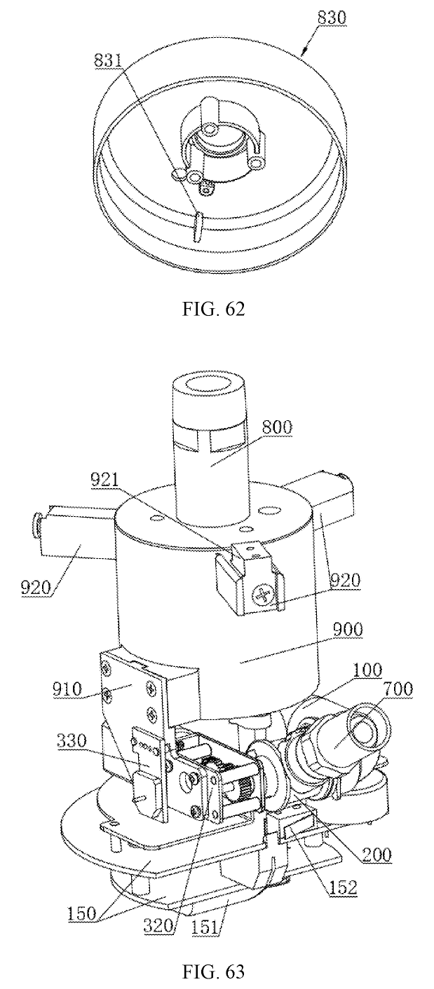

Referring to FIGS. 59-63, in one or more embodiments of the present application, a second sealing structure 120 is provided between the liquid-inlet end of the connecting pipe 100 and the stator 800. This second sealing structure 120 includes a second sealing groove 121 provided on the stator 800, and a second sealing ring 122 mounted within the second sealing groove 121, the second sealing ring 122 being in close contact with the inner wall of the water-inlet end of the connecting pipe 100.

The water-inlet end of the connecting pipe 100 is provided with a connecting plate 130, and bolts fix the connecting plate 130 to the bottom of the rotor 900. Bolts mount the control circuit board 150 on the mounting plane 140, and the control circuit board 150 is connected to the coil winding 810 and the rotary drive source 310. The control circuit board 150 is connected to a fire sensor 151, the fire sensor 151 employing conventional technology such as a smoke sensor, a combined smoke-and-temperature sensor, a temperature sensor, a flame sensor, or an infrared thermal imager.

The bottom surface of the top cover 830 is provided with a limiting block 831. A proximity block 921 is mounted on top of the connecting post 920, and the proximity block 921 is provided with a second proximity switch 922 and a third proximity switch 923. When the rotor 900 rotates, in either the forward or reverse direction, to the end of its travel, the second proximity switch 922 contacts the limiting block 831. The control circuit board 150 is fitted with a first proximity switch 152 corresponding to the spray nozzle 700; wherein the rotor 900 uses the second proximity switch 922 as its starting-point reference and the third proximity switch 923 as its end-point reference. The spray nozzle 700 uses the first proximity switch 152 as its starting-point reference.

By way of example, the operating process of the fire extinguishing device of the present application is as follows:

When the fire sensor 151 detects that a fire has occurred, it precisely sends a trigger signal to the control circuit board 150. Upon receiving this signal, the control circuit board 150 simultaneously confirms, via the signal from the second proximity switch 922, that the rotor 900 is at its rotational starting position, and confirms, via the signal from the first proximity switch 152, that the spray nozzle 700 is at its rotational starting position.

Subsequently, the control circuit board 150 energizes the coil winding 810, driving the rotor 900 to rotate a specified angle; at the same time, the rotary drive source 310 is activated. The rotary drive source 310, via the driving member 311, drives the receiving shaft 322 to rotate; the receiving shaft 322, through the meshing engagement of the first transmission member 326 and the second transmission member 327, successively drives the intermediate shaft 325 and the output shaft 324 to rotate. The output shaft 324, through the cooperation of the bolt 230 with the locking hole 240, drives the insertion pipe 200 and the spray nozzle 700 at its end to rotate.

During this rotation, rotation of the receiving shaft 322 simultaneously drives rotation of the rotating shaft 332. The position sensor 330 senses the rotation angle of the rotating shaft 332 in real time and sends the angle signal to the control circuit board 150. The control circuit board 150 thereby determines the angle through which the insertion pipe 200 has rotated. Once the insertion pipe 200 and the spray nozzle 700 have rotated to the specified angle, the control circuit board 150 controls the rotary drive source 310 to stop operating; once the rotor 900 has rotated to the specified angle, the control circuit board 150 controls the coil winding 810 to de-energize, thereby stopping its rotation.

Next, the control circuit board 150 controls the opening of the solenoid valve 154 on the water inlet pipe 153. The fire extinguishing medium flows in through the water inlet pipe 153, successively flowing through the medium channel 820, the connecting pipe 100, and the insertion pipe 200, and finally is ejected at high speed from the spray nozzle 700. The ejected fire extinguishing medium effectively covers the fire source area, delaying the spread of the fire and even extinguishing the fire source. In addition, when the fire extinguishing medium is clean water, the control circuit board 150 can further control the rotary drive source 310 to output forward and reverse rotational power, driving the spray nozzle 700 to swing back and forth, thereby further expanding the fire extinguishing coverage area and ensuring that the fire source is completely extinguished.

It should be particularly noted that, in the present application, the water outlet of the water inlet pipe 153 is connected only to the connecting pipe 100, so that the fluid path is simple and free of extraneous rotary joints that would cause pressure loss, thereby ensuring that the water pressure within the water inlet pipe 153 remains stable, and thereby ensuring that, under the same angular conditions, the ejection angle and distance are consistent each time.

The above embodiments illustrate, but do not limit, the present application; any solution obtained by simple modification of the present application falls within the scope of protection of the present application.

What is claimed is:

1. A fluid ejection mechanism, comprising:
a connecting pipe, an interior of the connecting pipe permitting fluid to flow therethrough for introducing an external fluid;
an insertion pipe, an end of the insertion pipe being connected via insertion to an end of the connecting pipe and in fluid communication therewith, wherein the insertion pipe and the connecting pipe are configured to be rotatable relative to each other circumferentially at a location of insertion;
a rotating assembly drivingly connected to the insertion pipe for driving the insertion pipe to rotate about its own central axis; and
a spray nozzle fixedly mounted on the insertion pipe and in communication with an interior of the insertion pipe, wherein the spray nozzle is configured to swing synchronously with rotation of the insertion pipe so as to directionally spray the fluid to a target location;
wherein
a first space is provided at the end of the connecting pipe;
a second space corresponding to the first space is provided at the end of the insertion pipe; and
the fluid ejection mechanism further comprises a limiting member being positioned in both the first space and the second space so as to achieve mutual axial limiting between the connecting pipe and the insertion pipe while allowing the connecting pipe and the insertion pipe to rotate relative to each other circumferentially.

2. The fluid ejection mechanism according to claim 1, wherein
the first space is an annular groove provided along at least a partial circumference of an outer peripheral surface of the end of the connecting pipe; and
the second space is an annular hole provided along a partial circumference of the end of the insertion pipe.

3. The fluid ejection mechanism according to claim 1, wherein
the first space is an annular hole provided along a partial circumference of the end of the connecting pipe; and
the second space is an annular groove provided along at least a partial circumference of an outer peripheral surface of the end of the insertion pipe.

4. The fluid ejection mechanism according to claim 2, wherein the limiting member comprises:
a first limiting portion and a second limiting portion, respectively located on two radial sides of the connecting pipe and each inserted into both the first space and the second space; and
a connecting portion, connecting the first limiting portion and the second limiting portion and, in a radial direction of the connecting pipe, clamping the first limiting portion and the second limiting portion against the connecting pipe.

5. The fluid ejection mechanism according to claim 4, wherein
the first limiting portion and the second limiting portion are each detachably connected to the connecting portion;
the connecting portion is provided with a slot;
the first limiting portion and the second limiting portion are each provided with an insertion block adapted to fit the slot; and
the insertion block is each inserted into the slot so as to fixedly connect the connecting portion to the first limiting portion and the second limiting portion.

6. The fluid ejection mechanism according to claim 5, wherein the limiting member further comprises
an elastic bushing, the elastic bushing being mounted between the insertion block and the slot so that the insertion block and the slot are in interference fit with each other.

7. The fluid ejection mechanism according to claim 5, wherein the limiting member further comprises
a locking member, the locking member being detachably fixed to an outer periphery of the insertion block so as to fix the connecting portion to the first limiting portion and the second limiting portion.

8. The fluid ejection mechanism according to claim 5, wherein the limiting member further comprises
a fixing member, the fixing member being detachably fixed within the insertion block so as to fix the connecting portion to the first limiting portion and the second limiting portion.

9. The fluid ejection mechanism according to claim 1, wherein
the first space is a through hole extending radially at the end of the connecting pipe;
the second space is an annular groove extending circumferentially on an outer peripheral surface of the end of the insertion pipe; and
the limiting member is configured as a ball and is simultaneously embedded in the first space and the second space so as to axially limit the connecting pipe and the insertion pipe relative to each other.

10. The fluid ejection mechanism according to claim 1, wherein
the first space is an annular groove extending circumferentially on an outer peripheral surface of the end of the connecting pipe;
the second space is a through hole extending radially at the end of the insertion pipe; and
the limiting member is configured as a ball and is simultaneously and rollably embedded in the first space and the second space so as to axially limit the connecting pipe and the insertion pipe relative to each other.

11. The fluid ejection mechanism according to claim 9, wherein
a first blocking piece is fixedly mounted at an opening of the through hole of the first space near an outer peripheral surface of the connecting pipe for preventing the limiting member from disengaging from the first space.

12. The fluid ejection mechanism according to claim 11, wherein
the first blocking piece abuts against the limiting member in a length direction of the first space.

13. The fluid ejection mechanism according to claim 11, further comprising an elastic member located between the first blocking piece and the limiting member and compressed by both.

14. The fluid ejection mechanism according to claim 11, wherein
a support portion is provided at an opening of the through hole of the first space near an inner peripheral surface of the connecting pipe, the support portion having a reduced bore diameter, so as to support the limiting member and prevent the limiting member from falling out of the first space.

15. The fluid ejection mechanism according to claim 1, wherein
the first space is an annular groove extending circumferentially on an inner peripheral surface of the end of the connecting pipe;
the second space is an annular groove extending circumferentially on an outer peripheral surface of the end of the insertion pipe; and
the limiting member is a ball and is simultaneously and rollably embedded in the first space and the second space so as to axially limit the connecting pipe and the insertion pipe relative to each other.

16. The fluid ejection mechanism according to claim 1, wherein
the first space is an annular groove extending circumferentially on an outer peripheral surface of the end of the connecting pipe;
the second space is an annular groove extending circumferentially on an inner peripheral surface of the end of the insertion pipe; and
the limiting member is a ball and is simultaneously and rollably embedded in the first space and the second space so as to axially limit the connecting pipe and the insertion pipe relative to each other.

17. The fluid ejection mechanism according to claim 15, wherein
the connecting pipe is provided with a first communication hole extending radially and communicating with the first space, the limiting member entering the first space and the second space through the first communication hole, and
a second blocking piece is mounted at an opening of the first communication hole to prevent the limiting member from falling out of the first communication hole.

18. The fluid ejection mechanism according to claim 1, wherein the rotating assembly comprises:
a rotary drive source for providing rotational power;
a speed reducer, an input end of which is connected to the rotary drive source and an output end of which is connected to the insertion pipe, for transmitting the power output by the rotary drive source so as to rotate the insertion pipe about its central axis; and
a position sensor, connected to the speed reducer, for monitoring a rotation angle output by the speed reducer.

19. The fluid ejection mechanism according to claim 18, wherein
a driving member is fitted on a drive output shaft of the rotary drive source;
the speed reducer comprises:
a receiving shaft, meshed with the driving member and configured to rotate by receiving power from the driving member;
a reducer output shaft, connected to and configured to rotate synchronously with the insertion pipe;
a middle shaft located between the receiving shaft and the reducer output shaft;
wherein
the position sensor is a potentiometer provided with a plug-in hole;
a rotating shaft is provided, one end of which is fixedly inserted into the plug-in hole and the other end of which is connected to and configured to synchronously rotate with the receiving shaft, the reducer output shaft, the middle shaft, or the insertion pipe; or
one end of the insertion pipe is fixedly inserted into the plug-in hole.

20. A fire extinguishing device, comprising
a stator,
a rotor fitted around an exterior of the stator and rotating about the stator,
a coil winding provided on the stator or the rotor;
a medium channel provided through the stator, the medium channel being used for flow of a fire extinguishing fluid; and
the fluid ejection mechanism according to any one of claim 1;
wherein
the rotating assembly of the fluid ejection mechanism is mounted on the rotor, such that the fluid ejection mechanism as a whole rotates synchronously with the rotor;
a liquid-inlet end of the connecting pipe of the fluid ejection mechanism is movably connected to the stator,
a sealing structure is provided between the liquid-inlet end of the connecting pipe and the stator;
a first bearing and a second bearing are installed between the rotor and the stator; and
a retaining ring is provided on an outer wall of the stator, wherein the retaining ring abuts against the second bearing in an axial direction so as to limit relative separation between the stator and the rotor in the axial direction.
